(19) United States
(12) Patent Application Publication
(10) Pub. No.: US 2023/0121923 A1
(43) Pub. Date: Apr. 20, 2023

(54) SUPPORT MODULE FOR A FAN AND FAN HAVING A CORRESPONDING SUPPORT MODULE

(71) Applicant: ZIEHL-ABEGG SE, Künzelsau (DE)

(72) Inventors: Frieder LOERCHER, Braunsbach (DE); Sandra HUB, Pfedelbach (DE); Matthias GOELLER, Weissbach (DE)

(21) Appl. No.: 17/792,359

(22) PCT Filed: Dec. 4, 2020
(86) PCT No.: PCT/DE2020/200107

§ 371 Date: Jul. 12, 2022

(30) Foreign Application Priority Data
Jan. 14, 2020 (DE) 10 2020 200 363.7

(51) Int. Cl. F04D 29/62; F04D 25/08; F04D 25/06; F04D 29/02; F04D 29/44; F04D 29/66

(52) U.S. Cl. CPC F04D 29/626; F04D 25/08; F04D 25/06; F04D 29/023; F04D 29/444; F04D 29/667; F05D 2230/54

(57) ABSTRACT

A support module for a fan, which includes a motor and a fan impeller driven in rotation by the motor, in an embodiment for a radial or diagonal fan, for fastening the fan impeller between a nozzle plate on the inflow side and a base plate lying opposite the nozzle plate at a distance, wherein the motor is non-rotatably mounted with the fan impeller on or in the base plate and is held on the nozzle plate by means of struts extending between the base plate and the nozzle plate characterized in that the struts are adjusted to the flow exiting the fan impeller with a compact design. A fan is provided with a corresponding support module.

### CROSS-REFERENCE TO RELATED APPLICATIONS

This application is a national stage entry application under 35 U.S.C. 371 of PCT Patent Application No. PCT/DE2020/200107, filed on 4 Dec. 202, which claims priority to German Patent Application No. 10 2020 200 363.7, filed on 14 Jan. 2020, the entire contents of each of which are incorporated herein by reference.

### FIELD

The present disclosure relates to a support module for a fan, which includes a motor and a fan impeller driven in rotation by the motor, in particular for a radial or diagonal fan, for fastening the fan impeller between a nozzle plate on the inflow side and a base plate lying opposite the nozzle plate at a distance, wherein the motor is non-rotatably mounted with the fan impeller on or in the base plate and is held on the nozzle plate by means of struts extending between the base plate and the nozzle plate.

The disclosure also relates to a fan with a corresponding support module.

### SUMMARY

Basically, this is a support device that is used for fastening a motor with a fan impeller, with the motor and the fan impeller being usually fastened to a base plate of the support device. While the motor is non-rotatably arranged at its stator on the support device, the fan impeller rotates with the rotor of the motor. The arrangement of the base plate of the support device with motor and fan impeller is mechanically connected to the nozzle plate, which usually includes an inlet nozzle, and is, in other words, held on the nozzle plate. Struts that extend between the base plate and the nozzle plate are usually used for this purpose. These are fasteners in the broadest sense that space the nozzle plate from the base plate and stabilize the arrangement with the interposed fan impeller. Due to the arrangement of the struts, the arrangement of the components discussed above is to be understood as a structural unit.

The support devices known from practice, which provide the attachment of radial or diagonal fan impellers to the nozzle plate, are problematic insofar as the connecting struts extend downstream from the air outlet and, due to their provision, cause losses in efficiency, losses in air output and/or an increase in noise; at least they do not increase the static efficiency. On the other hand, the arrangement known from practice often requires a not inconsiderable amount of space, far from a compact design. Fans with known support devices have a pronounced, disruptive sub-harmonic noise, especially at operating points of high static pressure increases, since known support devices do not stabilize the flow downstream of the impeller.

The object of the present disclosure is therefore to at least reduce the aforementioned disadvantages. In concrete terms, the known support device is to be optimized into a support module by the special design of its struts and possibly also of the motor support plate or of the base plate in such a way that the losses and the increase in noise are minimal, with the aim being to increase the efficiency and the air output as much as possible. The supporting function of the support module, in particular when using special struts, should at least be maintained, if not even improved, and the support module should be compact when viewed in the radial direction.

In addition, a correspondingly optimized fan is to be specified, which includes a support module according to the disclosure. In combination with the support module according to the disclosure, the fan should have a significantly higher static efficiency than in the prior art, in particular when using a so-called GR module of the “spider” type. The support struts of such a GR module are usually formed from round material. The occurrence of a sub-harmonic rotational tone should be shifted to higher pressures compared to the prior art or be significantly reduced in a relevant operating range.

According to the disclosure, the aforementioned object is achieved with reference to the support module by means of the features of claim 1. Accordingly, the generic support module is characterized in that the struts are adjusted to the flow emerging from the fan impeller with a compact design.

At this point it should be noted that the term “strut” is to be understood in the broadest sense within the framework of the teaching, which is initially claimed in a very general manner. These are stabilizing spacers between the base plate supporting the motor and the fan impeller, and the nozzle plate. The struts should form a compact unit due to their rigidity/strength and their number and distribution around the fan impeller and at least reduce, if possible eliminate, the disadvantages occurring in the prior art due to their adaptation to the flow exiting the fan impeller.

In principle, the struts can be flat, planar components as well as profiled components, with different types of struts being able to be combined with one another. It is also conceivable that one type of strut replaces another type of strut.

In concrete terms, the struts can have a curvature and/or a varying thickness in cross-section. In an embodiment, their shape and orientation are adjusted to the flow conditions after the air has exited radially from the fan impeller. The adjustment allows the flow to be stabilized and the efficiency can be increased and the sub-harmonic noise reduced, depending on the specific adjustment.

The struts are advantageously profiled, as a result of which the aforementioned adaptation to the air flow can be implemented. In an embodiment, the struts can have approximately the same or a similar cross-sectional contour as the blades of the fan impeller.

The struts have an upstream edge and a downstream edge. In an embodiment, the cross-section of the struts on the inflow side tends to have rounded edges, in contrast to the outflow-side edges, similar to an airfoil, in order to ensure an aerodynamically stable behavior of the struts with regard to varying angles of attack.

In a further embodiment, the struts have convexly curved surfaces on the suction side and concavely curved surfaces on the pressure side. Compared to an imaginary radial, the profile struts have a different angle at their inflow edge than at their outflow edge, which results from their curvature. The leading edge and trailing edge angles are designed in such a way that the efficiency of the fan is high and the noise generated by the fan is low.

In a further embodiment, the struts are arranged radially outside the air outlet of the fan impeller on the outflow side. In a further embodiment, the struts are parallel to the impeller axis. This allows the installation space to be minimized.

Depending on requirements, the number of struts can vary. At least four struts should be provided, it being possible to also provide six to ten struts depending on the required stability, depending on the size and intended use of the support module or of the fan comprising the support module.

As already explained above, the struts have a supporting function, namely hold the base plate with the motor and the impeller on the nozzle plate. In addition, the provision of the struts can be used to promote the flow, in accordance with the specific configuration of the struts discussed above.

Depending on the requirements, the struts can be made from different materials and accordingly using different processes. The struts can be produced as aluminum profiles or sheet steel using the extrusion process, or as plastic profiles using the injection molding process. It is important to note whether the struts are the only components that take on the supporting function or whether additional stabilizing and therefore supporting components are provided.

In addition to the struts or instead of the struts, side parts can be provided in or near the corner regions of the nozzle plate, which extend between the nozzle plate and the base plate. These can be independent components that are connected to the nozzle plate and the base plate. These side parts are arranged radially outside the air outlet of the fan impeller on the outflow side and, in an embodiment, parallel to the impeller axis.

At this point it should be emphasized that the aforementioned side parts are a type of struts, but with a different specific form, which supplement the profiled struts discussed above, but can also replace them in individual cases.

The side parts are, in an embodiment, arranged at a small distance from the optionally corresponding struts, such that the side parts are aligned at their leading edges with the corresponding struts at their trailing edge at a small distance, so that the side parts and struts with their leading edges and trailing edges form an aerodynamically effective unit.

In addition, the side parts may be arranged close to the corner regions between the nozzle plate and the base plate and/or close to the struts, for example directly adjacent to them.

The side parts can be designed as flat plastic injection-molded parts or as flat metal sheets, with stabilizing embossing, beads, etc. being able to be provided. In and embodiment, at least four of these side parts are provided, with six to ten side parts, for example eight side parts, being provided alone or in addition to the struts discussed above, depending on the size and use of the support module.

In accordance with the above statements, the side parts can have a supporting function and hold the base plate and the motor with the impeller on the nozzle plate. They should also stabilize the air flow and thereby increase efficiency and reduce sub-harmonic noise as much as possible.

In an embodiment, the profiled struts and the rather flat side parts are connected to one another in pairs, by means of suitable connecting means, resulting in a specific arrangement and alignment of the struts and side parts provided in pairs. Due to this measure, the arrangement of the strut and side part acts as an aerodynamic unit and can promote the flow.

In concrete terms, the struts and/or side parts may have the smallest possible distance from their inflow edges to the trailing edges of the impeller blades. This again favors the compact design with favorable flow conditions.

To attach the struts and side parts, in an embodiment, they have attachment means at their axial ends for attachment to corresponding attachment regions of the base plate and to the nozzle plate, the connection being made by screws, rivets, gluing or welding. A firm connection is essential to bring about the required stability or rigidity.

With regard to the nozzle plate and base plate, in an embodiment, these components have an edge region with folded edges that stiffen or stabilize the two plates. On top of that, the folded edges provide ideal fastening regions for the struts and/or the side parts.

The base plate and, if necessary, the nozzle plate can be made of sheet metal or plastic, using suitable manufacturing processes as a basis.

In an embodiment, the base plate can have a square or polygonal contour with chamfered corners, in which case the contour can in principle also be rectangular. A contour with chamfered corners may be used when the fan comprising the support module is installed in an air duct or the like with axial air routing. In an embodiment, the base plate of the support module extends radially over the entire circumference by at least 10% over the entire impeller or over the base disk of the impeller. In a further embodiment, the base plate of the support module does not have any openings or openings that are relevant to flow technology within its radial outer contour. These features of the base plate of the support module ensure the flow-stabilizing effect of the support module, which increases the static efficiency and reduces sub-harmonic noise.

Finally, with regard to the support module, the radial extension of the nozzle plate may define the radial installation space of the support module. This is due to the specific arrangement and design of the struts and side parts.

The fan according to the disclosure is equipped with a support module of the type discussed above, as a result of which the efficiency losses, air output losses and noise increase occurring in the prior art due to the necessary provision of struts can be reduced, if not even eliminated. A fan with the support module according to the disclosure is also extremely stable with a compact design.

There are then various possibilities for advantageously designing and refining the teaching of the present disclosure. For this purpose, reference should be made on the one hand to the claims subordinate to claim 1 and on the other hand to the following explanation of exemplary embodiments of a fan according to the disclosure having also a support module according to the disclosure, with reference to drawings. In connection with the explanation of the exemplary embodiments of the disclosure with reference to drawings, embodiments and refinements of the teachings are also explained in general.

### BRIEF DESCRIPTION OF THE SEVERAL VIEWS OF THE DRAWINGS

FIG. 1 shows, in a perspective view seen from the inflow side, an exemplary embodiment of a fan with a support module according to the disclosure,

FIG. 2 shows, in an axial top view in a planar section seen from the outflow side, the fan with support module from FIG. 1,

FIG. 3 shows, in a perspective view from the side in a section on a plane through the axis, the embodiment of a fan with support module according to FIGS. 1 and 2,

FIG. 4 shows, in a perspective view, seen from the inflow side, a further exemplary embodiment of a fan with a support module according to the disclosure, the support module not having any side plates,

FIG. 5 shows, in an axial top view in a planar section seen from the outflow side, the fan with support module from FIG. 4,

FIG. 6 shows, in an axial top view in a planar section seen from the outflow side, the fan with support module from FIGS. 4 and 5,

FIG. 6a shows a detailed view of FIG. 6, wherein angle values are also shown schematically,

FIG. 7 shows, in a perspective view seen from the inflow side, an exemplary embodiment of a fan with a support module according to the disclosure having 4 profiled struts,

FIG. 8 shows, in schematic diagrams, the representation of the progression of the static pressure increases of a fan with standard suspension and of a fan with a support module according to the disclosure at constant speed,

FIG. 9 shows, in schematic diagrams, the representation of the progression of the static efficiencies of a fan with standard suspension and of a fan with a support module according to the disclosure at constant speed,

FIG. 10 shows, in schematic diagrams, the representation of the progression of the suction-side noise power levels of a fan with standard suspension and of a fan with a support module according to the disclosure at constant speed,

FIG. 11 shows, in schematic diagrams, the representation of spectra of the suction-side noise pressure of a fan with standard suspension and of a fan with a support module according to the disclosure at constant speed and the same volumetric flow rate, and

FIG. 12 shows, in an axial plan view in a planar section seen from the inflow side, the fan with support module according to FIGS. 4 to 6, installed in an air duct.

### DETAILED DESCRIPTION OF THE DISCLOSURE

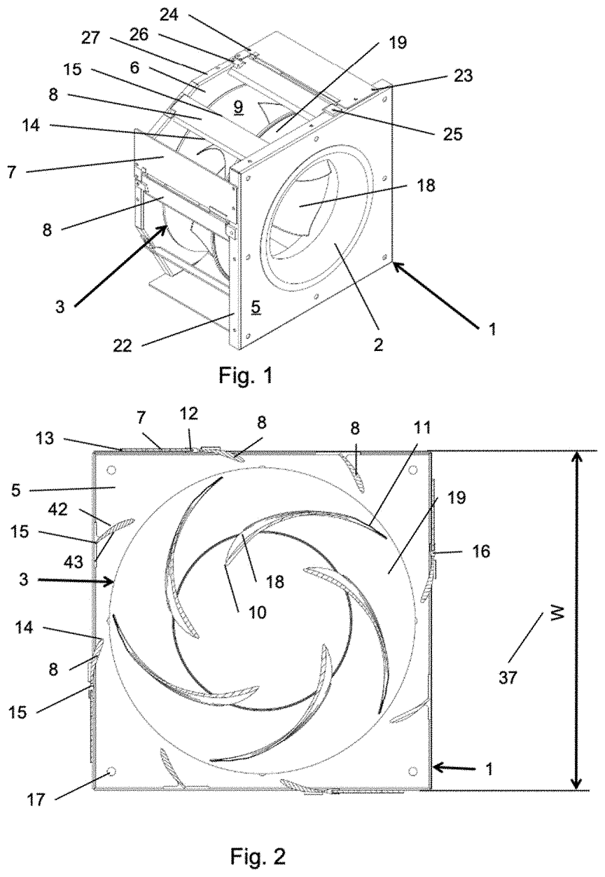

FIG. 1 shows, in a perspective view seen from the inflow side, an exemplary embodiment of a fan with a support module 1 according to the disclosure. The fan impeller 3, which may be of radial or diagonal design, is visible on the inside. The inlet nozzle 2 attached to a nozzle plate 5 can also be seen on the inflow side. In addition to the nozzle plate 5, the support module 1 includes a base plate 6 and 8 lateral struts 8 radially outside (outflow side) of the air outlet of the fan impeller 3. The struts are referred to below as profile struts 8 due to their design. The fan impeller 3 consists essentially of a base disk 9, a cover disk 19 and blades 18 extending in between.

In the exemplary embodiment according to FIG. 1, side parts 7 designed as side plates are present, which have a supporting function, namely they represent the supporting connection between the nozzle plate 5 and the base plate 6. The number of side plates 7, if present or necessary, may be four. If supporting side plates 7 are present, the profile struts 8 may be formed from plastic. The profile struts 8 and the side plates 7 cover part of the outflow region, which stabilizes the flow. The static efficiency of the fan is improved, particularly in the regions of the characteristic curve with high pressure. The side parts 7, may be made of sheet metal, are flat in the exemplary embodiment, that is to say they consist essentially of a one-piece continuous flat region. This is beneficial, though not required, for simple and cost-effective production of the support module 1 and its side parts 7.

Fastening provisions 23 and 24 are provided for connecting the side parts 7 to the nozzle plate 5 and base plate 6, respectively. In addition, fastening provisions 25 and 26 for connecting the profile struts 8 to the nozzle plate 5 and the base plate 6 are formed. The connection can be made in particular by screws, rivets, but also by welding. The nozzle plate 5 made of sheet metal has a folded region 22 on its outer edge, which stabilizes the nozzle plate 5 and into which parts of the fastening provisions 23 and 25 are integrated. The base plate 6 made of sheet metal has a folded region 27 on its outer edge, which stabilizes the base plate 6 and into which parts of the fastening provisions 24 and 26 are integrated. In other embodiments, the bottom plate 27 may be molded from plastic.

The sheet metal 6 on the side of the base disk extends radially up to the profile struts 8 and the side parts 7.

FIG. 2 shows the fan with support module 1 according to FIG. 1 in axial view from above and in a planar section, as seen from the outflow side. The essentially flat, supporting side parts 7 have an inflow-side edge 12 and an outflow-side edge 13. Viewed in cross section, the profile struts 8 are not flat, but rather have approximately the cross-sectional contour of an airfoil. This means that they have a curvature and a non-constant thickness and their shape and orientation are adjusted to the flow conditions that occur after the air has exited the impeller 3 in the radial direction to the outside. The blades 18 of the impeller 3, which are also profiled, have the inflow edges 10 and the outflow edges 11. The profile struts 8 have inflow edges 14 and outflow edges 15. The inflow edges 14 are, seen in cross section, rather round, similar to an airfoil, in order to ensure aerodynamically stable behavior of the profile struts 8 relative to different angles of attack. They have convexly curved suction-side surfaces 42 and concavely curved pressure sides 43. Compared to an imaginary radial, the profile struts have a different angle at their inflow edge 14 than at their outflow edge 15, which provides their curvature, seen in the cross section.

The leading edge and trailing edge angles are designed in such a way that the efficiency of the fan is high and the noise generated by the fan is low. The leading edges 12 of the flat side part 7 are not rounded, since the side part 7 is a flat sheet metal. However, the flat side parts 7 are aligned at their leading edges 12 exactly with corresponding profile struts 8 at their trailing edges 15 with a small distance, so that the side parts 7 with the corresponding profile struts 8 optimally act as an aerodynamic unit with leading edges 14 and trailing edges 13.

In the exemplary embodiment, the aerodynamically shaped profile struts 8 run parallel to the fan axis, which runs perpendicular to the plane of the drawing. Since the profile struts 8 in the exemplary embodiment are not supporting and may be made of plastic injection molding, a different path would also be conceivable, for example not parallel to the axis or with a variable cross section.

Fastening provisions 17 of the nozzle plate 5 or of the fan for fastening to a higher-level system such as an air-conditioning device or an air duct can be seen on the nozzle plate 5.

The support module 1 essentially does not protrude beyond the nozzle plate 5 in a viewing direction parallel to the axis, as shown here, and is therefore particularly compact when viewed in the radial direction and therefore requires little installation space. The support module 1 has an approximately rectangular, approximately square, cross section of width w (37) (in the case of a rectangular cross section, w is the larger width) W(37) is, in an embodiment, no greater than 1.25 times the mean diameter of the trailing edges 11 of the blades 18 of the impeller 3 with respect to the fan axis.

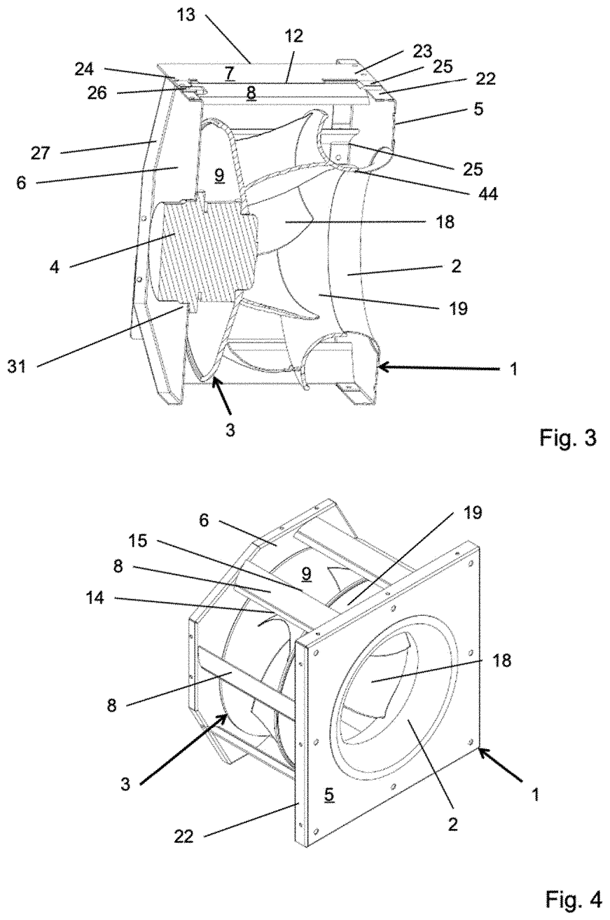

FIG. 3 shows, in a perspective view seen from the side and in a section on a plane through the axis, the exemplary embodiment of a fan with support module 1 according to FIGS. 1 and 2. During operation of the fan, air is sucked in from the right through the inlet nozzle 2 into the impeller 3 and conveyed radially outwards as a result of the rotation before it flows past the profile struts 8 and side plates 7 out of the support module 1. The impeller 3 with the blades 18 extending between the base disk 9 and the cover disk 19 is driven by a motor 4, shown schematically. The motor 4 is connected to the impeller 3 on the rotor side and fixed to the base plate 6 on the stator side. The motor 4 is fastened to the base plate 6 in a central region 31 which has, in an embodiment, a recess into which the motor 4 is inserted. Possible means for centering and fastening the motor 4 are provided. The inlet nozzle 2 is fastened to the nozzle plate 5 or can also be molded directly into the nozzle plate 5, for example by means of a deep-drawing process. The nozzle plate 5 has a folded region 22 which stabilizes the nozzle plate 5 and can be integrated into the fastening provisions 23 and 25. The folded region 22 also has a function for the flow conditions and thus for air output and efficiency. The flow in this region within the support module 2 is thus stabilized by the folded region 22, which has a positive effect on the secondary flow through the radial gap 44 between the inlet nozzle 2 and the cover disk 19. As far as the description of the profile struts 8 and the side plates 7 is concerned, reference is largely made to the description of FIGS. 1 and 2.

FIG. 4 shows a further exemplary embodiment of a fan with a support module 1 according to the disclosure in a perspective view seen from the inflow side. In contrast to the embodiment according to FIGS. 1 to 3, the support module 1 has no side plates. This means that the profile struts 8 assume the supporting function and hold the base plate 6, the motor and the impeller 3 on the nozzle plate 5. In order to meet the relevant strength requirements, the profile struts 8 may be made of metal. The design of the profile struts 8 as extruded aluminum profiles has proven to be particularly favorable and effective. However, it is also conceivable to manufacture them from high-strength plastic, cast aluminum or sheet steel. Extruded aluminum profiles in particular can be connected to the nozzle plate 5 or the base plate 6 by directly screwing in suitable screws through the metal sheet of the nozzle plate 5 or the base plate 6 (not shown). The impeller 3 with the base disk 9, the cover disk 19 and the blades 18 may be made in one piece by plastic injection molding. Other types of impellers are also conceivable, for example by welding steel or aluminum.

In other embodiments, the lateral profile struts 8 are made of sheet metal. For this purpose, a metal sheet can be curved or folded in a suitable manner in order to realize a profile shape or at least the curved center line of the profile shape, seen in a cross section analogously to FIG. 2.

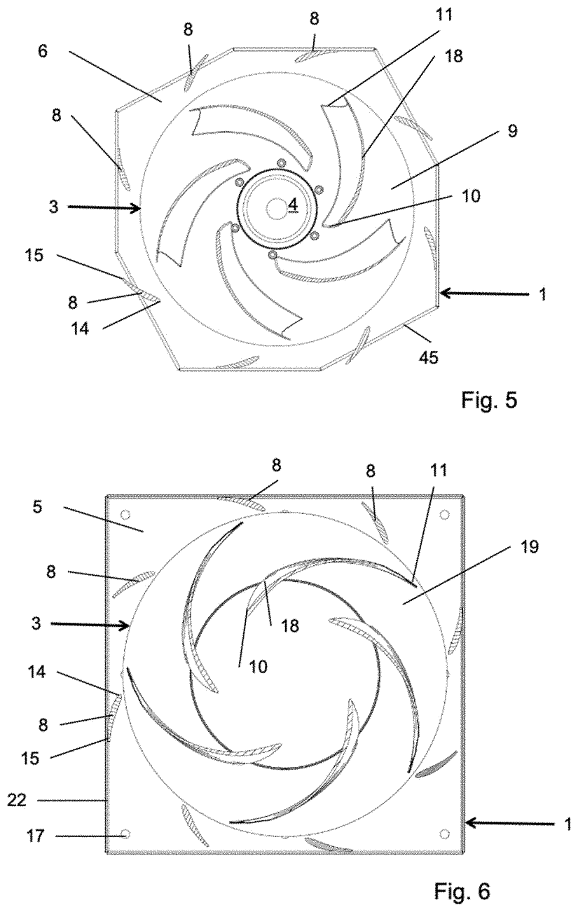

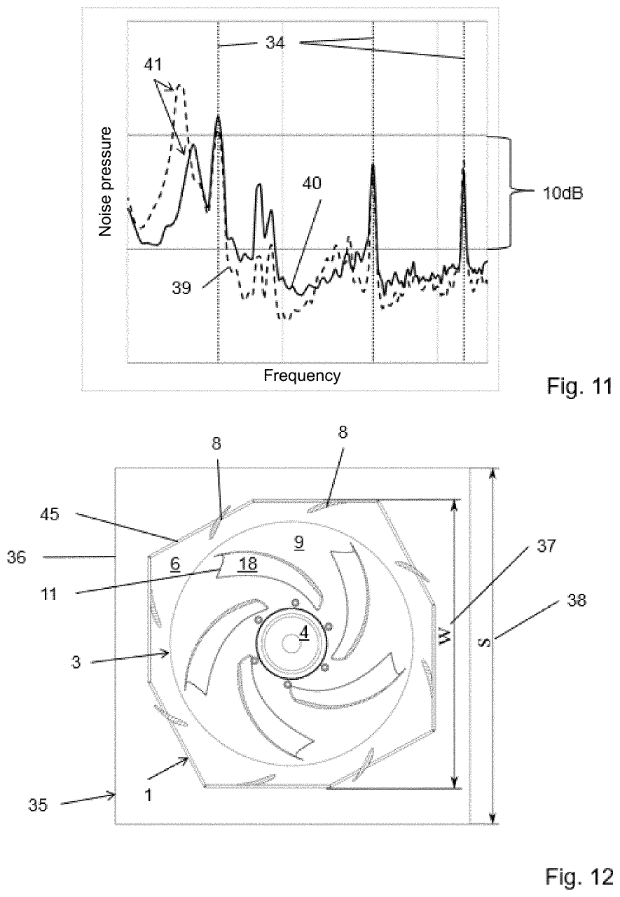

FIG. 5 shows the fan with support module 1 according to FIG. 4 in an axial top view and in a planar section as seen from the inflow side. The rotor of the motor 4 and the attachment of the base disk 9 of the impeller 3 to the motor 4 can be seen in the center. The aerodynamically advantageous design of the cross sections of the profile struts 8 can be clearly seen, similar to the design of airfoil cross sections, as also described with reference to FIG. 2. The air flowing out radially from the impeller 3 flows with low loss on the profile struts 8, first via their leading edge regions 14 and then via the thin trailing edge regions 15 from the support module 1. The profile struts 8 ensure through their design in interaction with the nozzle plate 5 and the base plate 6 a stabilization of the flow inside the support module 1 and thus an increase in efficiency and/or a reduction in noise, at least a sub-harmonic noise (noise in a frequency range below the blade repetition frequency, see also the description of FIG. 11). The outer contour of the base plate 6 resembles a square with chamfered corners 45 in an axial plan view. It can also have an approximately rectangular contour. The contouring with the chamfered corners 45 is particularly advantageous if the fan with the support module 1 according to the disclosure is installed in an air duct or the like with axial air routing, see also FIG. 12.

In the axial plan view according to FIG. 5, the base plate 6 of the support module 1 extends, viewed in the radial direction, continuously and over the entire circumference over the outer contour of the base disk 9 of the impeller 3. It may extend radially over the entire circumference without interruption by at least 10% over the base plate 9 of the impeller 3, in a further embodiment, it extends over the entire circumference without interruption by at least 10% radially over the entire impeller 3 including blades 18 and cover plate 19. The base plate 6 has no significant, aerodynamically relevant openings or breakthroughs (this does not include boreholes, cable breakthroughs, gaps due to manufacturing tolerances or the like)

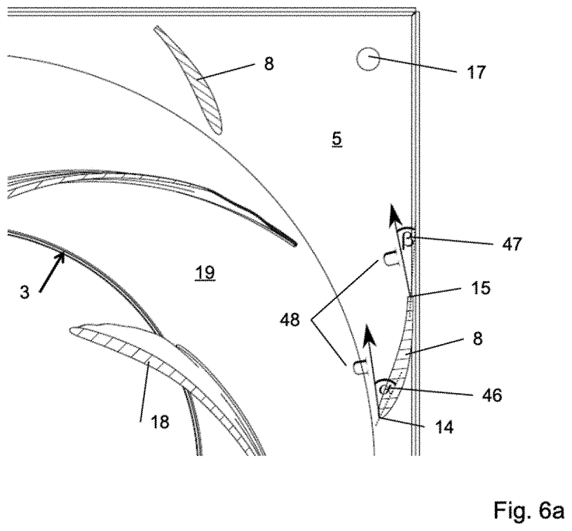

FIG. 6 shows the fan with support module 1 according to FIGS. 4 and 5 in an axial top view and in a planar section as seen from the outflow side. The trailing edges 11 of blades 18 of the impeller 3 have a relatively small distance from the inflow edges 14 of the profile struts 8, which is advantageous for the radial compactness of the support module 1 and thus of the fan, and is also advantageous for achieving a high level of efficiency. The blades 18 of the impeller 3 protrude with their leading edges 10 radially inward beyond the inner edge of the cover disk 19. The trailing edges 15 of the profile struts 8 do not protrude radially beyond the radial outer contour of the nozzle plate 5, namely the radial extension of the nozzle plate 5 defines the radial installation space of the compact support module 1 and thus of the fan. Fastening means 17 for fastening the fan to a higher-level system are provided on the nozzle plate 5.

FIG. 6a shows a detailed view of FIG. 6, wherein angle values are also shown schematically on a profile strut 8, namely the leading edge angle α 46 at the leading edge 14 and the trailing edge angle β 47 at the trailing edge 15. The leading edge angle α 46 is, as seen in one section on a plane perpendicular to the axis correspond to the representation according to FIG. 6a, the angle between the local circumferential direction U 48 and the profile center line at the inflow edge 14 of a profile strut 8. The trailing edge angle β 47 corresponds to a section on a plane perpendicular to the axis 6a, the angle between the local circumferential direction U 48 and the profile center line at the trailing edge 15 of a profile strut 8. In order to achieve optimal flow conditions and thus high efficiency and low noise generation, the leading edge angle α 46 and the trailing edge angle β 47 are optimally adjusted to the flow emerging from the impeller 3. α 46 is, in an embodiment, not equal to β 47, in a further embodiment a 46 is greater than β 47, an in a further embodiment by at least 10° greater. α 46 and β 47 are, in an embodiment, smaller than 45°.

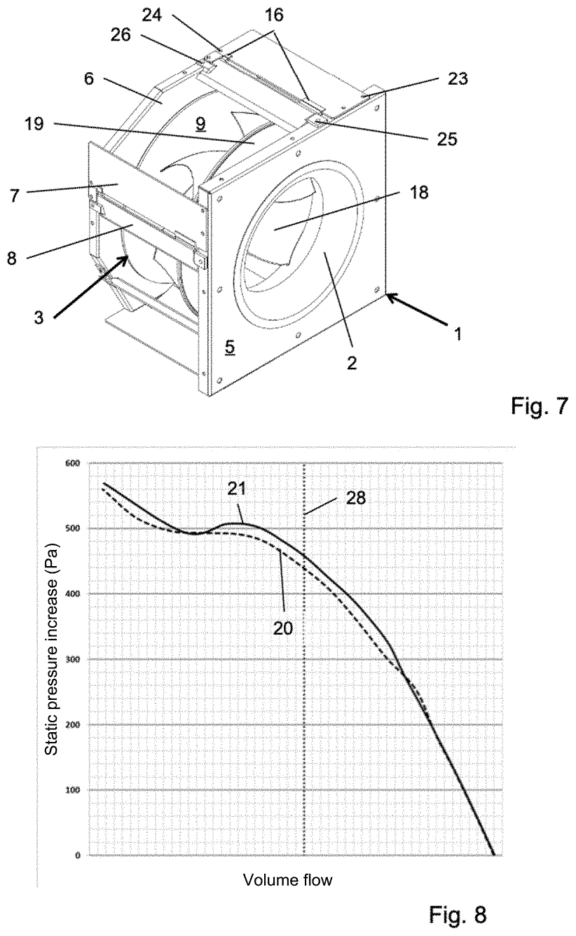

FIG. 7 shows a perspective view of a further exemplary embodiment of a fan with a support module 1 according to the disclosure, seen from the inflow side. In contrast to the embodiment according to FIGS. 1 to 3, the support module 1 in this embodiment has only four profile struts 8, namely no freestanding profile struts without assigned side plates. All four profile struts 8 are assigned to a side plate 7. The side plates 7 and the associated profile struts 8 are connected to one another with connecting elements 16 in order to ensure better alignment of the side plates 7 and the profile struts 8 to one another.

In other embodiments, the lateral profile struts 8 are made of sheet metal. For this purpose, a metal sheet can be curved or folded in a suitable manner in order to realize a profile shape or at least the curved center line of the profile shape, seen in a cross section analogously to FIG. 6a. In such embodiments too, the leading edge angle α 46 and the trailing edge angle β 47 are to be selected as previously described with reference to FIG. 6 in order to achieve high efficiencies and low noise emissions.

FIG. 8 shows the representation of the progression of the static pressure increases of a fan with standard suspension and of a fan with a support module according to the disclosure at constant speed. This representation illustrates the mode of operation of a support module according to the disclosure by comparing a characteristic curve of a fan with a support module according to the disclosure with a characteristic curve of an otherwise identical fan, in particular with the same impeller and the same motor, but in which the housing is replaced by a standard motor suspension, for example consisting of aerodynamically largely neutral round metal struts. Curve 20 shows the course of the static pressure increase for the fan with standard motor mounting (reference fan) as a function of the volumetric flow rate. The fan with the support module according to the disclosure has the characteristic curve 21 for the static pressure increase as a function of the volumetric flow rate. By using the support module according to the disclosure, noticeably larger increases in static pressure can be achieved than with a caseless fan, especially in regions with medium to low flow rates, in particular, depending on the embodiment, a maximum gain of 2% to 15% in static pressure increase at the same speed and the same flow rate can be reached. The dotted line 28 shows an exemplary volumetric flow, which is also used as a basis for the following descriptions of the figures. With this volumetric flow rate, the use of a support module according to the disclosure increases the static pressure increase by about 8% from about 480 Pa to about 520 Pa, for example.

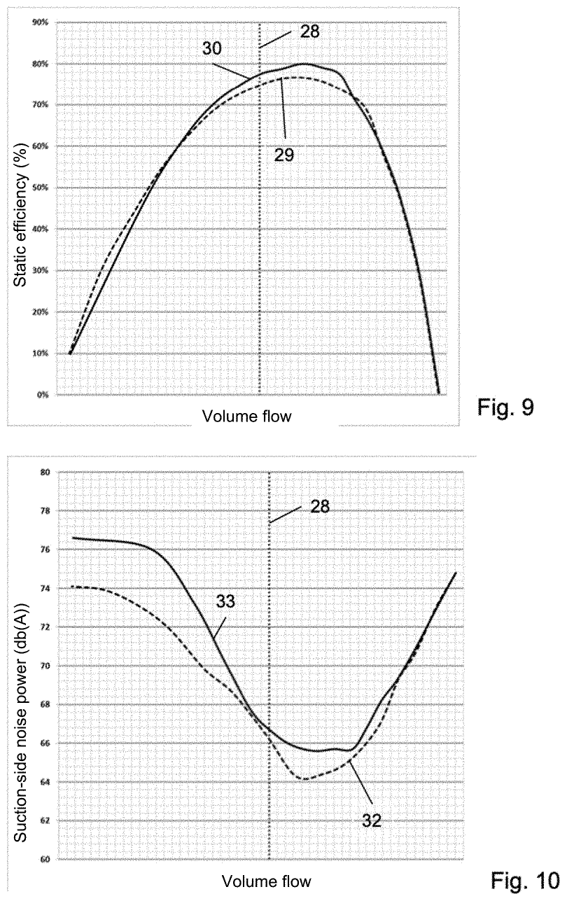

FIG. 9 shows a schematic representation of the curves of the static efficiencies as a function of the volumetric flow rate of a fan with standard suspension and a fan with a support module according to the disclosure at a constant speed. The static efficiency achieved in each case is plotted as a function of the volumetric flow at constant speed. The dashed efficiency curve 29 is obtained with measurements of a backward-curved centrifugal fan with standard suspension (reference fan), whereas the solid efficiency curve 30 is obtained with measurements of the same fan but using a support module according to the disclosure instead of a standard suspension. It is easy to see that the efficiency is noticeably increased by a support module according to the disclosure, particularly in regions with medium to low volume flows, that is to say with rather high static pressure increases (cf. FIG. 9). In the case of high volume flows or low static pressure increases, the improvement tends to be less. In the region of medium to low volume flows or high static pressure increases, the improvement is a few percentage points, in particular at the point of maximum increase it is at least 2 percentage points or at least 3% relative. The dotted line 28 shows the same exemplary volume flow that is also used in FIG. 8. At this volume flow, the static efficiency is increased by 3 percentage points or about 4% relatively by using a support module according to the disclosure instead of a standard suspension from about 74.5% to about 77.5%

FIG. 10 shows the curves of the suction-side noise power level of a fan with standard suspension and a fan with a support module according to the disclosure at the same and constant speed. The dashed curve 32 represents the progression of the suction-side noise power of the reference fan as a function of the air volume flow, and for comparison, the solid curve 33 represents the suction-side noise power of the otherwise identical fan but with the support module according to the disclosure instead of a standard suspension. Noise power values for both fans are approximately the same over large regions of the characteristic curve, but are somewhat higher in the case of the fan with a support module according to the disclosure. This is primarily due to the interaction of the impeller with the side parts and/or the profile struts, which, in order to achieve high radial compactness of the fan with a support module according to the disclosure, are relatively close to the air outlet from the impeller or to the blade trailing edges of the impeller.

Furthermore, a constant air volume flow 28 is drawn in as a dotted line. For this air volume flow, which is the same as in FIGS. 8 and 9, noise pressure spectra are shown in FIG. 11 for comparison. It should be mentioned again at this point that all of the curves shown in FIGS. 8-11 correspond to an identical and constant speed, wherein an at least structurally identical impeller and an at least structurally identical motor have always being used.

FIG. 11 shows the representation of spectra of the suction-side noise pressure of a fan with standard suspension and a fan with a support module according to the disclosure at constant speed and at the same volumetric flow rate 28, which is shown in FIGS. 8-10. The dashed curve 39 shows the noise pressure spectrum of the reference fan and the solid curve 40 shows the noise pressure spectrum of the fan with the support module according to the disclosure at the volumetric flow rate 28 (FIGS. 8-10). The frequency resolution in the diagram shown is 3.125 Hz. With other frequency resolutions, however, the same qualitative effects can be seen. The three frequencies 34 plotted are the first, second and third harmonics of the blade repetition rate of the fan impeller. They correspond to one, two or three times the product of the rotational frequency of the impeller in revolutions per second and the number of impeller blades. The noise at the first harmonic of the blade repetition frequency is also referred to as a rotary tone. In the range of these frequencies, the noise pressure is significantly increased both for the reference fan (curve 39) and for the fan with the support module according to the disclosure (curve 40) compared to the general trend of the curves, with the noise pressure in particular at the first blade repetition frequency for the fan with the support module according to the disclosure being higher than for the reference fan. This is due in particular to the interaction of the impeller blades with the side plates and/or the profile struts. However, what is decisive for the effectiveness of the support module according to the disclosure is the increase in the noise pressure curves in the form of regions of excessive increase 41. The noise corresponding to this is referred to as sub-harmonic noise. In the case of backward-curved fans, it regularly occurs at a frequency of around 60%-90% of the first blade repetition frequency, particularly at operating points with higher static pressure increases. It can be seen that the sub-harmonic noise, which is generally dependent on the volumetric flow rate, is significantly reduced at the illustrated volumetric flow rate for the fan with a support module according to the disclosure, in the example shown by around 7-8 dB, generally by 1-15 dB, depending on the volumetric flow rate and frequency resolution. The frequency of the sub-harmonic noise is also shifted slightly, by about 5%-20% of the first blade repetition frequency. This reduction and frequency shift of the sub-harmonic noise at operating points with medium to low volumetric flow rate and rather large static pressure increases is caused by a flow stabilization due to the support module according to the disclosure. This is a very characteristic feature of a support module according to the disclosure. Depending on the embodiment, the remaining noise, for example the noise at a harmonic of the blade repetition frequency 34 or the broadband noise, can be higher or lower in a fan with a support module according to the disclosure than in the reference fan. Only the reduction of the sub-harmonic noise in the fan with housing is decisive for the description of the mode of action. However, it is typical that the noise at the first harmonic of the blade repetition frequency is increased in the fan with the support module according to the disclosure compared to the reference fan. In an embodiment, this noise can be reduced with active noise canceling, namely the cancellation of noise by introducing out of phase noise. This is technically simple, since the blade repetition frequency can be easily determined when the fan speed is known.

FIG. 12 shows the fan with support module 1 according to FIGS. 4 to 6, installed in an air duct 35, in an axial top view and in a planar section as viewed from the inflow side. The inner fan impeller 3 with blades 18 and the base disk 9 and further out the eight profile struts 8 are visible in this figure. The support module 1 has at least approximately 90° rotational symmetry with respect to the fan axis.

The support module 1 has a width w (37) in the section shown or in an axial plan view. The width is determined by the side length of the smallest square defined around the support module 1 in a section on a plane perpendicular to the axis or in an axial plan view. The width w (37) of the support module 1 is, in an embodiment, 1.15-1.3 times the mean diameter D of the trailing edges 11 of the blades 18 of the fan impeller 3, which expresses the radial compactness of the support module 1 in relation to the impeller 3. If the width w is variable in different sectional planes, the maximum width w seen over the entire axial height of the support module 1 must be used for the evaluation, without taking the nozzle plate into account.

The air duct 35 has four side walls 36. According to the section from FIG. 12, it has a width s (38). If an air duct has a roughly rectangular cross-section with different side lengths s1 and s2, s can either be determined as the lower value of s1 and s2 or according to the formula s·s=s1·s2. If a plurality of fans with housings 1 are installed in parallel in an air duct, only the imaginary region of the air duct 35 assigned to each fan is considered, as if partition walls were always inserted in between adjacent fans parallel to the side walls 36 of the air duct 35. The width s (38) of the air duct 35 assigned to a fan is, in an embodiment, in the range of 1.2 times to 1.8 times the width w (37) of the associated support module 1 or in the range of 1.5 times to 2.3 times the average diameter D of the trailing edges 11 of the blades 18 of the fan impeller 3.

If the ratio s/w of the width s (38) of the air duct 35 assigned to a fan and the width w (37) of the associated support module 1 is less than 1.4, it can be advantageous to provide chamfered corners 45 on the support module 1 so that the out-flowing air in the axial direction has more flow surface between the base plate 6 and the air duct wall 36.

To avoid repetition with regard to further embodiments of the support module according to the disclosure and of the fan according to the disclosure including the support module, reference is made to the general part of the description and to the appended claims.

Finally, it should be expressly noted that the above-described exemplary embodiments of the support module according to the disclosure and of the fan according to the disclosure are used solely to explain the claimed teaching, but do not restrict it to the exemplary embodiments.

### LIST OF REFERENCE NUMERALS

1 support module
2 inlet nozzle
3 fan impeller
4 Motor
5 nozzle plate
6 base plate of the support module
7 side part, side plate of the support module
8 lateral profile strut
9 base disk of the impeller 3
10 inflow edge, leading edge of a blade 18
11 outflow edge, trailing edge of a blade 18
12 Upstream edge of a side plate 7
13 downstream edge of a side plate 7
14 upstream edge of a lateral profile strut 8
15 downstream edge of a lateral profile strut 8
16 connecting element side plate 7-lateral profile strut 8
17 fastening provision, fastening means, nozzle plate-higher-level system
18 blade of the fan impeller 3
19 cover plate of the fan impeller
20 exemplary characteristic curve of the static pressure with standard suspension
21 exemplary characteristic curve of the static pressure with the support module according to the disclosure
22 folded region of the nozzle plate 5
23 fastening provisions side plate 7-nozzle plate 5
24 fastening provisions side plate 7-base plate 6 of support module 1
25 fastening provisions between a lateral profile strut 8 and the nozzle plate 5
26 fastening provisions between a lateral profile strut 8 and the nozzle plate 6
27 folded region of the base plate 6
28 exemplary operating point (volumetric flow)
29 exemplary characteristic curve of the static pressure with standard suspension
30 exemplary characteristic curve of the static efficiency with the support module according to the disclosure
31 central region of the base plate 6
32 exemplary characteristic curve of the suction-side noise power with standard suspension
33 exemplary characteristic curve of the suction-side noise power with the support module according to the disclosure
34 rotor blade frequency harmonics
35 air duct
36 side wall of the air duct 35
37 width w of the support module 1
38 width s of the air duct 35
39 spectrum of the noise pressure at the exemplary volume flow 28 with standard suspension
40 spectrum of the noise pressure at the exemplary volume flow 28 with the support module according to the disclosure
41 sub-harmonic noise increase regions
42 suction side of profile struts 8
43 pressure side of the profile struts 8
44 radial gap between inlet nozzle 2 and cover plate 19
45 chamfered corner of base plate 6
46 leading edge angle α of the profile struts 8
47 trailing edge angle β of the profile struts 8
48 circumferential direction with respect to the axis

1. A support module for a fan, comprising:
a motor;
a fan impeller driven in rotation by the motor, the support module fastening the fan impeller between a nozzle plate on the inflow side and a base plate lying opposite the nozzle plate at a distance, wherein the motor is non-rotatably mounted with the fan impeller on or in the base plate and is held on the nozzle plate by means of struts extending between the base plate and the nozzle plate, wherein
the struts are adjusted to the flow emerging from the fan impeller.

2. The support module of claim 1, wherein the struts have a curvature in cross section and their shape and orientation are adjusted in particular according to the flow conditions after the air has exited radially from the fan impeller.

3. The support module of claim 1, wherein the struts have a varying thickness in cross section.

4. The support module of claim 1, wherein the struts are profiled and have approximately the same or a similar cross-sectional contour as the blades of the fan impeller.

5. The support module of claim 1, wherein the struts have rather rounded edges when viewed in cross section on the inflow side.

6. The support module of claim 1, wherein the struts have convexly curved suction-side surfaces and concavely curved pressure-side surfaces.

7. The support module of claim 1, wherein the struts are arranged radially outside an air outlet of the fan impeller on an outflow side, parallel to the impeller axis.

8. The support module of claim 1, comprising:
at least 4 struts,
6 to 10 struts, and
8 struts.

9. The support module of claim 1, wherein the struts support and hold the base plate and the motor with the impeller on the nozzle plate.

10. The support module of claim 1, wherein the struts are produced as one of:
aluminum profiles;
sheet steel using an extrusion process; and,
plastic profiles using an injection molding process.

11. The support module of claim 1, wherein, side parts are provided in or near corner regions of the nozzle plate, which extend between the nozzle plate and the base plate, the side parts being arranged radially outside an air outlet of the fan impeller on an outflow side, parallel to the impeller axis.

12. The support module of claim 11, wherein the side parts are arranged at a small distance from corresponding struts, such that the side parts are aligned at their leading edges with the corresponding struts at their trailing edges at a small distance therefrom, wherein side parts and struts form an aerodynamically effective unit with their leading edges and trailing edges.

13. The support module of claim 11, wherein the side parts are at least one of:
arranged close to the corner regions between the nozzle plate or the base plate; and
close to the struts.

14. The support module of claim 11, wherein the side parts are flat plastic injection molded parts or as-flat metal sheets.

15. The support module of claim 11, comprising:
at least 4 side parts,
6 to 10 side parts, and
4 side parts.

16. The support module of claim 11, wherein the side parts have support and hold the base plate and the motor with the impeller on the nozzle plate.

17. The support module of claim 11, wherein mutually associated struts and side parts are connected to one another in pairs by connecting means in a specific arrangement and alignment with one another.

18. The support module of claim 11, wherein inflow edges of the struts and/or side parts preferably have the smallest possible spacing preferably from the trailing edges of the impeller blades.

19. The support module of claim 11, wherein the struts and side parts have fastening regions at their ends for fixing to corresponding fastening regions of the base plate and on the nozzle plate, the connection being made by screwing, riveting, gluing, or welding.

20. The support module of claim 19, wherein fastening provisions on the nozzle plate and the base plate are associated with respective edge folds which stiffen or stabilize the two plates.

21. The support module of claim 1, wherein the base plate and optionally the nozzle plate are made of sheet metal or plastic.

22. The support module of claim 1, wherein the base plate has a quadrangular or polygonal contour with chamfered corners.

23. The support module of claim 1, wherein a radial extent of the nozzle plate defines a radial installation space of the support module.

24. The support module of claim 1, wherein, in a comparison of a suction-side narrow-band noise pressure spectra of a fan with a support module and an otherwise identical fan in which the support module has been replaced by a motor suspension which largely does not affect the flow conditions, with a volumetric flow rate which lies on a fan characteristic curve for constant speed in a range of higher pressure increases, in the case of the noise pressure spectrum corresponding to the fan with support module, the maximum sub-harmonic noise pressure increase in a frequency range between 70% and 90% of the first blade repetition frequency is at least 3 dB lower.

25. A fan with a motor and a fan impeller driven in rotation by the motor, with a support module according to claim 1.
